(19) United States
(12) Patent Application Publication
(10) Pub. No.: US 2009/0205184 A1
(43) Pub. Date: Aug. 20, 2009

(54) FASTENER INSTALLATION TOOL

(75) Inventors: Angraj Kumar Seewraj, Hertfordshire (GB); Peter Michael Beecherl, Algonac, MI (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: Avdel UK Limited, Hertfordshire (GB)

(21) Appl. No.: 12/305,423

(22) PCT Filed: Jan. 28, 2008
(86) PCT No.: PCT/GB2008/000276

§ 371 Date: Feb. 3, 2009

(30) Foreign Application Priority Data
Mar. 16, 2007 (GB) 0705144.4

(51) Int. Cl. B23P 11/00

(52) U.S. Cl. 29/243.54

(57) ABSTRACT

The present invention provides a hydro-pneumatically operated fastener installation tool (2), including a head (4) having hydraulically driven gripping and pulling means for gripping and pulling the stem of a fastener, thereby to install the fastener, and a hydraulic inlet port (6) provided in the head (4) for supplying hydraulic fluid to a cylinder (8) to drive the gripping and pulling means, wherein the cross-sectional shape of the hydraulic inlet port (6) is non-circular, such that a cross section of the inlet port (6) has a longitudinal axis and lateral axis, wherein the longitudinal axis runs widthways across the tool head (4).

This invention relates to fastener installation tools, and in particular to installation tools for installing breakstem fasteners, wherein a part of the fastener is broken off during installation.

Fastener installation tools for breakstem fasteners, such as a blind rivet or bolt, install the fastener by applying a relative pulling action to the stem of the fastener, until the stem is caused to break at a weakened or breakneck point, leaving part of the stem plugging the body of the fastener. The tool may incorporate a pneumatic or hydraulic intensifier, whereby the pulling stroke of the head is actuated when hydraulic fluid enters an inlet port provided in the forging (or casting) of the tool head. Such tools are well known, for example those available under the trade mark Genesis.

The inlet port extends into the tool head from a bore formed in the forging. Currently known tools have inlet ports which are circular in cross-section.

During the broaching of a fastener by the installation tool, the pressure within the head of the tool reaches a peak. This pressure peak consequently causes stresses in the head forging, and particularly around the hydraulic inlet port. The operational life of the head is consequentially limited, as it will eventually fail by cracking around the hydraulic inlet port. The tool is therefore rendered unusable until a replacement head has been fitted.

The value of the pressure peak within the head on broaching increases with the broach load which must be applied to install the fastener, i.e. the force which must be applied to cause the fastener stem to fracture at the breakneck point.

It is an aim of the present invention to overcome or at least mitigate the above problems.

Accordingly, the present invention provides, in one aspect, a hydro-pneumatically operated fastener installation tool, including a head having hydraulically driven gripping means for gripping and pulling the stem of a fastener, thereby to install the fastener, and a hydraulic inlet port provided in the head for supplying hydraulic fluid to a cylinder to drive the gripping and pulling means, wherein the cross-sectional shape of the hydraulic inlet port is non-circular, such that a cross section of the inlet port has a longitudinal axis and lateral axis, wherein the longitudinal axis runs widthways across the tool head.

An advantage of the present invention is that stress around the hydraulic inlet port in the tool head caused on fastener broaching is minimised. Consequently, potential deterioration of the tool head is minimised and the operating life of the head lengthened in comparison to currently known tool heads.

A further advantage is that the tool head can be compatible with known installation tools such that it is interchangeable with currently known tool heads.

Preferably the hydraulic inlet port is oval in cross-section. The inlet port may also be formed of an irregular oval, or an elongated slot, which could be fully radiused at each end.

The central axis of the inlet port may be perpendicular to the central axis of the head cylinder.

An embodiment of the present invention will now be described by way of example and with reference to the accompanying drawings in which:

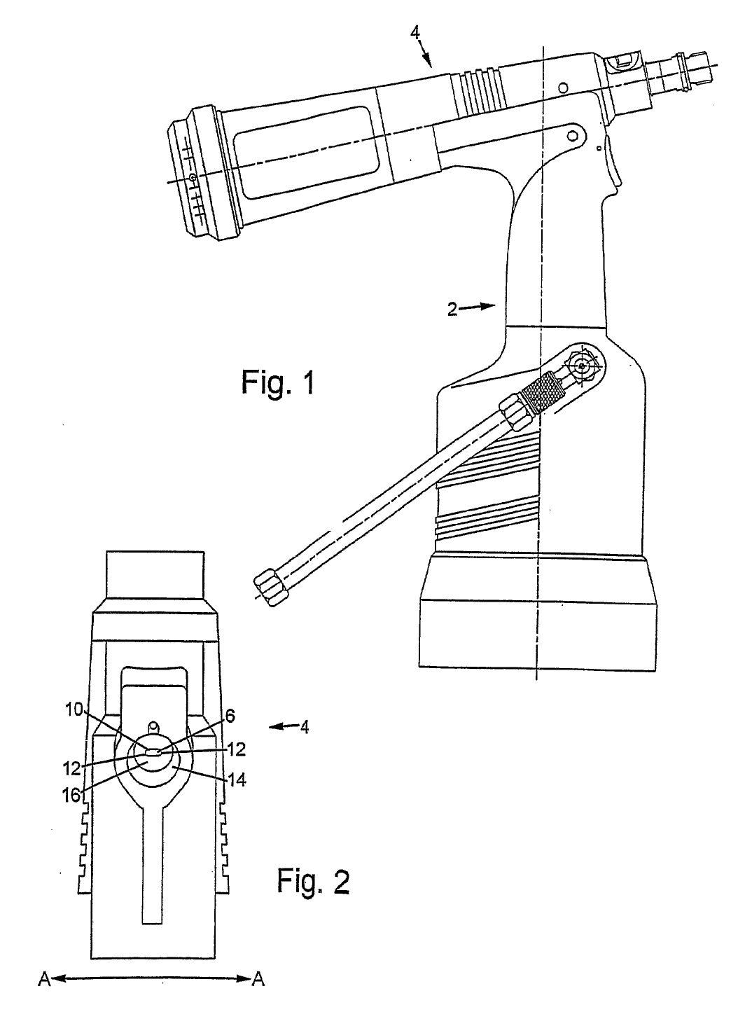

FIG. 1 is a side elevation of an installation tool in accordance with the present invention;

FIG. 2 is an elevation of the underside of the head of the installation tool of FIG. 1;

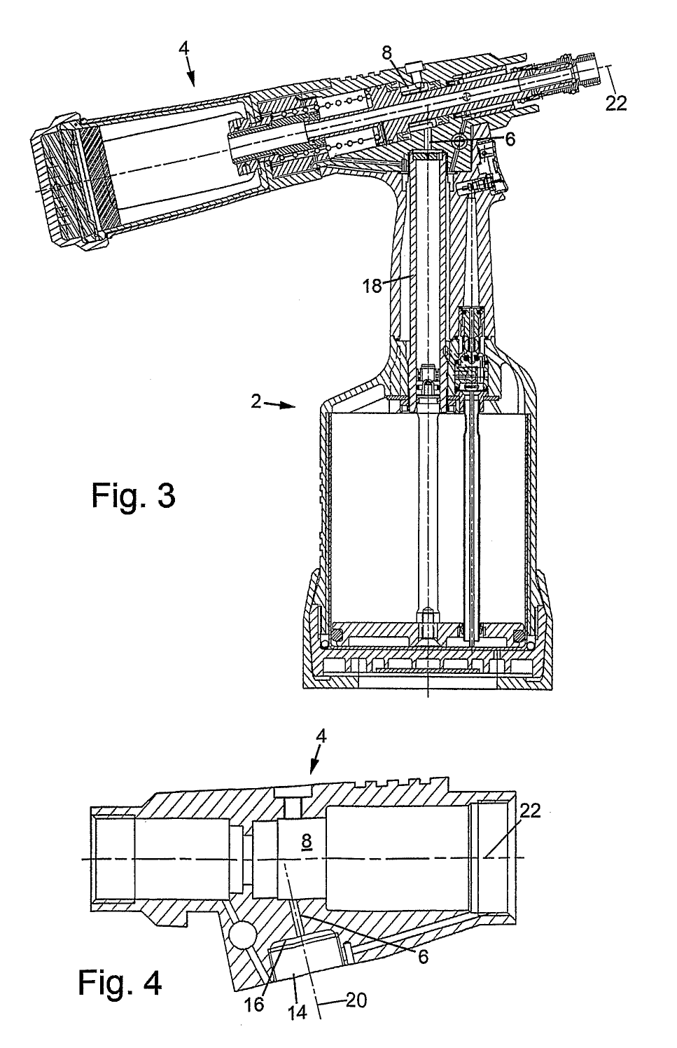

FIG. 3 is a longitudinal cross-section of the head of the installation tool of FIG. 1.

FIG. 4 is an axial cross-section of the head of the installation tool of FIG. 1.

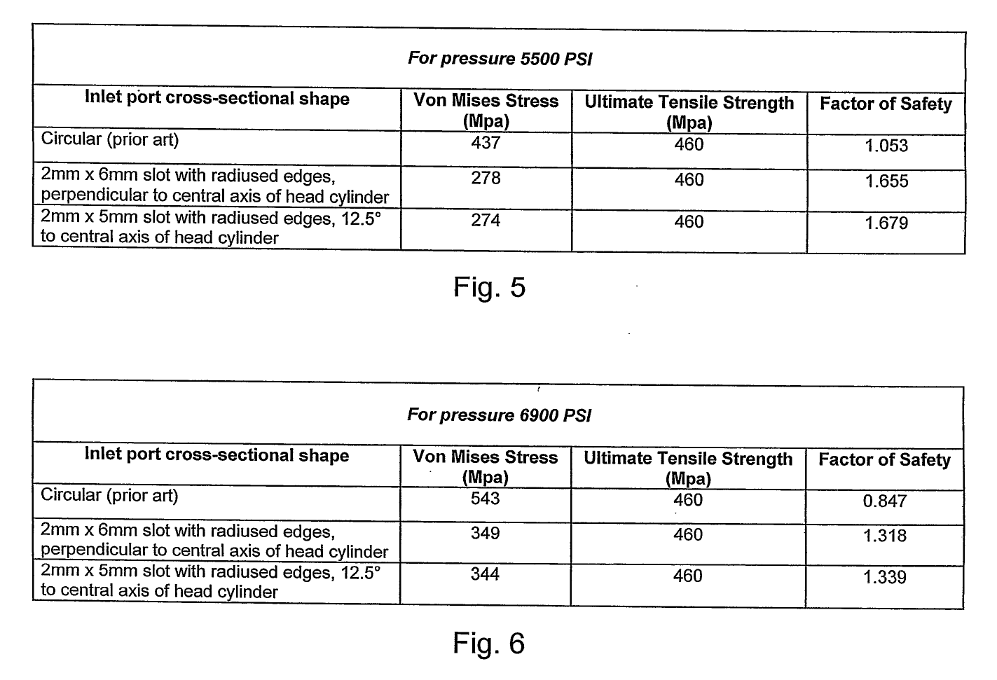

FIGS. 5 and 6 are comparison tables of maximum stresses encountered in currently known tool heads and embodiments of tool heads according to the invention, at internal tool head pressures of 37.92 MPa and 47.57 MPa respectively.

Referring to FIGS. 1 and 2, the present invention provides a fastener installation tool 2 having a tool head 4. An inlet port 6 is provided in the tool head 4 to allow hydraulic fluid to enter a head cylinder 8 provided in the head 4.

As illustrated in FIG. 2, the inlet port 6 comprises an elongated slot 10 with a full radii at each end 12. The longitudinal axis of a cross-section of the slot 10, i.e. the axis extending between the ends 12, run widthways across the tool head 4, i.e. in the direction of arrow A on FIG. 2, and the lateral axis of the cross-section runs lengthways across the tool. The inlet port 6 extends from the inner surface 16 of a bore 14 (which accepts an intensifier tube 18 (FIG. 3) when the head is attached to the tool), to the head cylinder 8. As illustrated in FIG. 4, the central axis 20 of the inlet port 6 is normal to the inner surface 16, and is therefore angled relative to the central axis 22 of the head cylinder.

Referring to the tables of FIGS. 5 and 6, the maximum stress occurring in a metal tool head of a tool according to the present invention is lower than that which occurs in the prior art, wherein the inlet port has a circular cross-section.

In an alternative embodiment, the inlet port 6 may not be normal to the inner surface 16 of the bore 14. For example, the inlet port 6 could be arranged to be perpendicular to the axis of the head cylinder 8. Therefore the longitudinal axis of a cross-section of the inlet port 6 would be perpendicular to the axis of the head cylinder 8. This embodiment represents the second entry on the tables of FIGS. 5 and 6.

The effective cross-sectional area of the inlet port 6 of the present invention may be the equal to that of the circular port provided in currently known tool heads.

1. A hydro-pneumatically operated fastener installation tool, including a head having hydraulically driven gripping and pulling means for gripping and pulling the stem of a fastener, thereby to install the fastener, and a hydraulic inlet port provided in the head for supplying hydraulic fluid to a cylinder to drive the gripping and pulling means, wherein the cross-sectional shape of the hydraulic inlet port is non-circular, such that a cross section of the inlet port has a longitudinal axis and lateral axis, wherein the longitudinal axis runs widthways across the tool head.

2. A fastener installation tool as claimed in claim 1, wherein the cross-sectional shape of the inlet port is oval.

3. A fastener installation tool as claimed in claim 1, wherein the cross-sectional shape of the inlet port is an irregular oval.

4. A fastener installation tool as claimed in claim 1, wherein the cross-sectional shape of the inlet port is a longitudinal slot.

5. A fastener installation tool as claimed in claim 4, wherein at least one end of the longitudinal slot is fully radiused.

6. A fastener installation tool as claimed in claim 1, wherein a central axis of the inlet port is perpendicular to a central axis of the head cylinder.

7. (canceled)
